(19) United States
(12) Patent Application Publication
(10) Pub. No.: US 2016/0371238 A1
(43) Pub. Date: Dec. 22, 2016

(54) COMPUTING DEVICE AND METHOD FOR CONVERTING UNSTRUCTURED DATA TO STRUCTURED DATA

(71) Applicant: BLUEPRINT SOFWARE SYSTEMS INC,, Ontario (CA)

(72) Inventors: Sam HEAVENRICH, Toronto (CA); Jerry CHENG, Toronto (CA); Richy RONG, Toronto (CA); Chuhan XIONG, Toronto (CA)

(21) Appl. No.: 14/903,871

(22) PCT Filed: Jul. 8, 2014
(86) PCT No.: PCT/CA2014/000556

§ 371 Date: Jan. 8, 2016

Related U.S. Application Data
(60) Provisional application No. 61/844,197, filed on Jul. 9, 2013.

(51) Int. Cl. G06F 17/22; G06F 17/30; G06F 17/27; G06F 17/24; G06F 17/21

(52) U.S. Cl. CPC G06F 17/2264; G06F 17/248; G06F 17/212; G06F 17/2705; G06F 17/30569

(57) ABSTRACT

A computing device and method are provided for converting unstructured data to structured data having a predetermined format. The computing device includes a memory storing unstructured data, an input device, a display, and a processor. The processor retrieves the unstructured data, loads parsing rules defining associations between properties of the unstructured data and the predetermined format, and applies the parsing rules to the unstructured data, dividing the unstructured data into sections. The sections contain portions of the unstructured data in fields defined by the predetermined format, and are presented on the display. A template is generated based on the sections, including, for each section, a record identifying the properties of the unstructured data contained in that section, and identifying corresponding fields of the predetermined format and values for those fields. The template is stored, and the sections are stored as structured data.

### FIELD

The specification relates generally to the processing of electronic documents, and specifically to a computing device and method for converting arbitrarily unstructured data to structured data.

### BACKGROUND

Software applications that process data may require the data to be structured according to specific formats compatible with those applications. Electronic data, however, may be stored in a wide variety of formats, many of which are not compatible with a given application. Electronic data may therefore be difficult or impossible to automatically process using a certain application until it has been converted to the appropriate formats. Such conversion processes may require extensive user manipulation and be prone to errors, resulting in an inefficient use of computing resources.

### BRIEF DESCRIPTIONS OF THE DRAWINGS

Embodiments are described with reference to the following figures, in which:

FIG. 1 depicts a computing device for converting unstructured data, according to a non-limiting embodiment;

FIG. 2 depicts a schematic representation of unstructured data, according to a non-limiting embodiment;

FIG. 3 depicts a method of converting the unstructured data of FIG. 2, according to a non-limiting embodiment;

FIG. 4 depicts an example performance of block 330 of FIG. 3, according to a non-limiting embodiment;

FIG. 5 depicts the results of the parsing of FIG. 4, according to a non-limiting embodiment;

FIG. 6 depicts an edited version of the results of FIG. 5, according to a non-limiting embodiment;

FIG. 7 depicts the computing device of FIG. 1 following the performance of the method of FIG. 3, according to a non-limiting embodiment;

FIG. 8 depicts structured data resulting from the performance of the method of FIG. 3, according to a non-limiting embodiment;

FIG. 9 depicts a schematic representation of updated unstructured data, according to a non-limiting embodiment; and

FIG. 10 depicts the results of the parsing of FIG. 4 on the unstructured data of FIG. 9, according to a non-limiting embodiment.

### DETAILED DESCRIPTION OF THE EMBODIMENTS

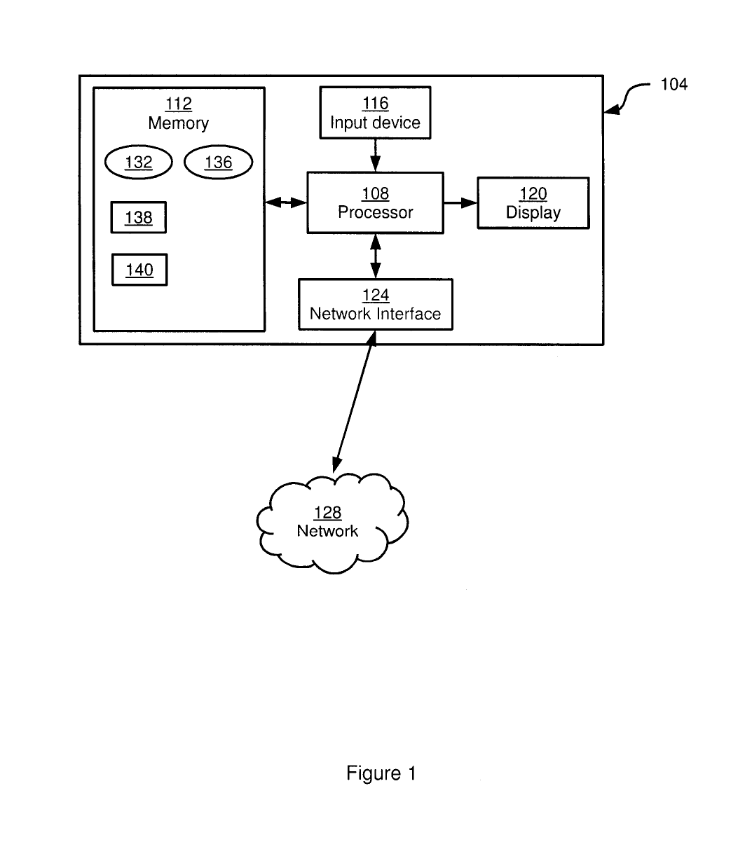

FIG. 1 depicts a computing device 104 configured to convert unstructured data contained within an electronic document into structured data. Before further discussion of the data conversion, the hardware components of computing device 104 will be described.

Computing device 104 can be based on any suitable server or personal computer environment. In the present example, computing device 104 is a desktop computer housing one or more processors, referred to generically as a processor 108.

Processor 108 is interconnected with a non-transitory computer readable storage medium such as a memory 112. Memory 112 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In the present example, memory 112 includes both a volatile memory and a non-volatile memory, both of which store data. Various ways of allocating data to one or both of the volatile memory and the non-volatile memory to support storage and processing activities will now occur to those skilled in the art.

Computing device 104 also includes one or more input devices, generically represented as an input device 116, interconnected with processor 108. Input device 116 can include any one of, or any suitable combination of, a keyboard, a mouse, a microphone, a touch screen, and the like. Such input devices are configured to receive input from the physical environment of computing device 104 (e.g. from a user of computing device 104), and provide data representative of such input to processor 108. For example, a keyboard can receive input from a user in the form of the depression of one or more keys, and provide data identifying the depressed key or keys to processor 108.

Computing device 104 also includes one or more output devices interconnected with processor 108, such as a display 120 (e.g. a Liquid Crystal Display (LCD), a plasma display, an Organic Light Emitting Diode (OLED) display, a Cathode Ray Tube (CRT) display). Other output devices, such as speakers (not shown), can also be interconnected with processor 108. Processor 108 is configured to control display 120 to present images to a user of computing device 108. Such images are graphical representations of data in memory 112. It is contemplated that input device 116 and display 120 can be connected to computing device 104 remotely, via another computing device (not shown). In other words, computing device 104 can be a server, while input device 116 and display can be connected to a client of the server that communicates with the server via network 128.

Computing device 104 also includes a network interface 124 interconnected with processor 108, allowing computing device 104 to communicate with other devices (not shown) via a network 128. The nature of network 128 is not particularly limited. Network 128 can be any one of, or any suitable combination of, a local area network (LAN), a wide area network (WAN) such as the Internet, and any of a variety of cellular networks. Network interface 124 is selected for compatibility with network 128. Thus, for example, when network 128 is the Internet, network interface 124 can be a network interface controller (NIC) capable of communicating using an Ethernet standard.

The various components of computing device 104 are connected by one or more buses (not shown), and are also connected to an electrical supply (not shown), such as a battery or an electrical grid.

Computing device 104 is configured to perform various functions, to be described herein, via the execution by processor 108 of applications consisting of computer readable instructions maintained in memory 112. Specifically, memory 112 stores a software design application 132 and a conversion application 136. A variety of other applications can also be stored in memory 112, but are not relevant to the present discussion. It is contemplated that in some embodiments, applications 132 and 136 can be combined in a single application; however, for ease of understanding, they are described as separate applications below.

When processor 108 executes the instructions of applications 132 and 136, processor 108 is configured to perform various functions in conjunction with the other components of computing device 104. Processor 108 is therefore described herein as being configured to perform those functions via execution of application 132 or 136. Thus, when computing device 104 generally, or processor 108 specifically, is said to be configured to perform a certain task, it will be understood that the performance of the task is caused by the execution of application 132 or 136 by processor 108, making appropriate use of memory 112 and other components of computing device 104.

Software design application 132, also referred to as application 132, enables computing device 104 to store and process data related to the design of new software applications. As such, application 132 allows for the management (e.g. creation, storage and updating) of requirements for a new software application, and can also generate technical specifications based on those requirements, for delivery to programming staff to write computer readable instructions forming the new software application based on the technical specifications. The types of requirements, also referred to as artifacts, managed by application 132 include the following: arbitrary strings of text; business process diagrams (for example, following the Business Process Model and Notation standard); use case diagrams (for example, defined using Unified Modeling Language), use case activity flowcharts, user interface mockups, domain model diagrams, storyboards, glossaries, embedded documents, and the like. The above types of requirement are not limiting, and other types of requirements that will occur to those skilled in the art can also be managed by computing device 104 via execution of application 132.

The activities that computing device 104 is configured to perform when executing application 132 (e.g. creating and updating requirements for the new software application, generating technical specifications) are not directly relevant to the present description, and will therefore not be discussed in detail. Discussions of such activities are provided in US Published Patent Application Nos. 2012/0210295 and 2012/0210301, the contents of which are hereby incorporated by reference. The storage of data for use by application 132 is, however, relevant to the present discussion, and will now be addressed.

The above-mentioned requirements are stored as structured data 138 in memory 112. Structured data 138 is accessed by processor 108 during the execution of application 132, and conforms to a predetermined data model, also referred to as a predetermined format, that processor 108 is configured to use during such execution. In other words, processor 108 is configured to process data stored according to the predetermined format (such as structured data 138) via execution of application 132. Data that does not conform with that predetermined format may not be usable by processor 108 during the execution of application 132. That is, such non-conforming data may not be compatible with application 132.

In the present example, the predetermined format used by application 132 is based on Extensible Markup Language (XML), and thus structured data 138 contains one or more XML files. The predetermined format therefore defines a plurality of machine-readable elements each containing a particular type of data. A given element can be used to contain data defining a specific type of artifact (e.g. a use case artifact), or data defining a certain aspect of an artifact (e.g. a block in a use case diagram), for example. Thus, elements can contain other elements (indeed, elements defining artifacts can contain other elements also defining artifacts). In addition, each element can have various attributes (e.g. a name for the above-mentioned use case artifact). The predetermined format also defines hierarchical relationships between elements, thus specifying which elements contain which other elements.

The nature of the predetermined format used by application 132 is not particularly limited. Although an XML-based format is discussed herein for illustrative purposes, other suitable formats can also be employed. In general, the predetermined format defines a plurality of machine-readable fields having hierarchical relationships, and defines what type of data is contained in each field (e.g. an artifact, a specific property of an artifact, and the like). Processor 108, via execution of application 132, is configured to detect the machine-readable fields and process the data in those fields to carry out the requirements management functionality mentioned above.

Conversion application 136, also referred to herein as application 136, enables computing device 104 to convert unstructured data into structured data for use by application 132. The term “unstructured” as used herein does not indicate that the unstructured data has no structure at all. Rather, “unstructured data” is data that does not conform with the predetermined format used by application 132. Unstructured data may in fact have any of a wide variety of defined structures used by applications other than application 132, but those structures do not match the predetermined format of application 132. As a result, the unstructured data cannot readily be used by processor 108 during the execution of application 132, since the unstructured data does not contain the machine-readable fields that processor 108 is configured to detect. In addition, in the examples to be discussed below, unstructured data does not contain elements that correspond directly, in a one-to-one relationship, to elements defined by the predetermined format of application 132.

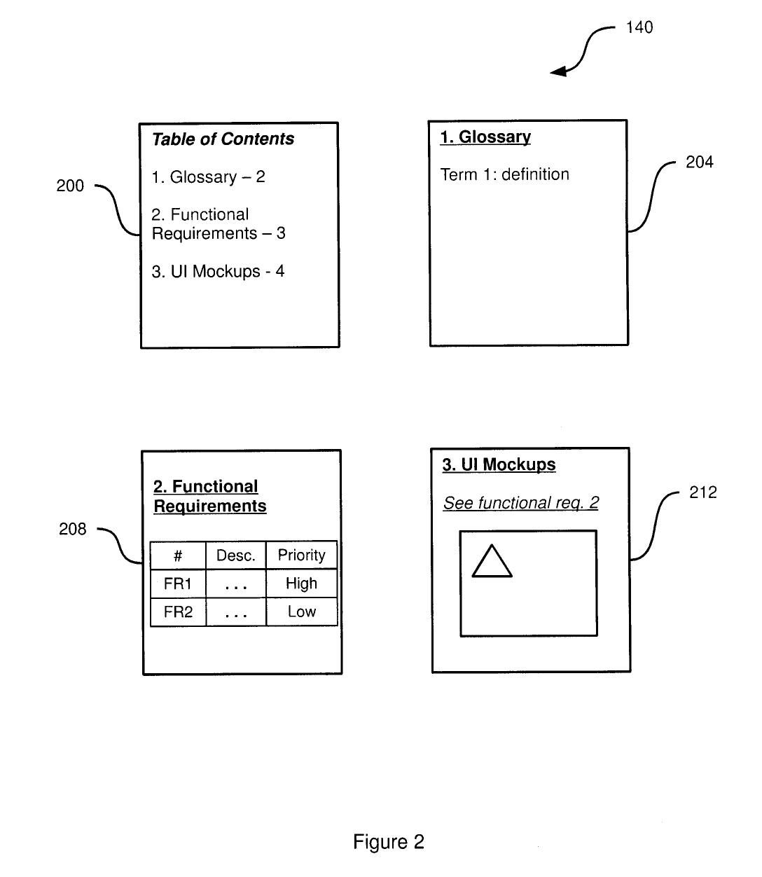

As seen in FIG. 1, memory 112 stores unstructured data 140 in the form of an electronic document. In the present example, unstructured data 140 is a Microsoft® Word document that conforms with the Office Open XML format, but it is contemplated that unstructured data 140 can use a variety of other formats (except the predetermined format used by application 132). Turning to FIG. 2, a schematic illustration of unstructured data 140 is shown.

FIG. 2 depicts an electronic document with four pages 200, 204, 208 and 212. Each page contains data that at least partly represents artifacts for use by application 132. For example, page 204 defines glossary requirements for a new software application. However, because unstructured data 140 complies with the Office Open XML format rather than the predetermined format used by application 132, the data shown in FIG. 2 is stored in fields according to properties such as font size, indentation, line spacing and the like. In other words, unstructured data 140 is formatted in such a way that not only is not compatible with application 132, but also does not correspond in a one-to-one relationship with the predetermined format of application 132. For example, the text “1. Glossary” in page 204 may be stored using elements to indicate that the text is bold, other elements to indicate that the text is underlined, other elements to indicate the indentation of the text, and still other elements to indicate that the text is single-spaced. None of those elements directly correspond to the elements of the predetermined format used by application 132. That is, none of the above-mentioned elements indicate that the text “1. Glossary” describes a glossary-type artifact.

Therefore, in order to adapt unstructured data 140 for use by processor 108 during the execution of application 132, processor 108 is configured to execute application 136 to convert unstructured data 140 to structured data 138.

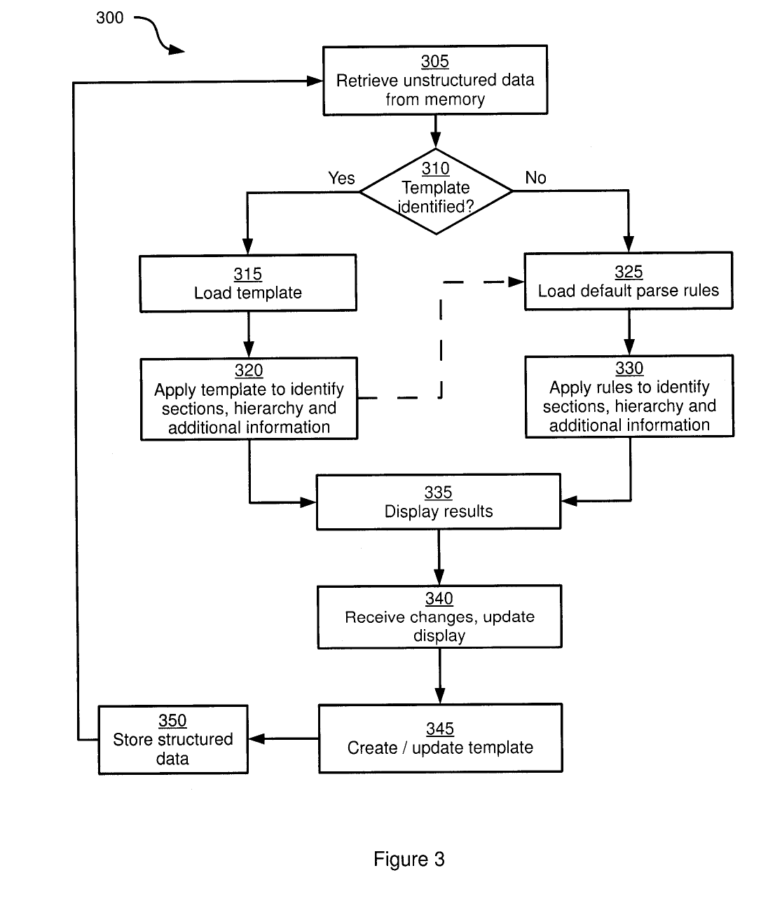

Referring now to FIG. 3, a method 300 of converting unstructured data to structured data is illustrated. The performance of method 300 will be described in conjunction with its performance in computing device 104, but it is contemplated that other suitable computing devices can also implement method 300 and variations thereof. The functionality implemented by computing device 104 during the performance of method 300 is implemented as a result of the execution by processor 108 of conversion application 136.

Beginning at block 305, computing device 104 is configured to retrieve unstructured data 140 from memory 112. The origin of unstructured data 140 is not particularly limited—it can be received earlier via network interface 124, or via another interface such as a universal serial bus (USB) (not shown). At block 305, processor 108 is configured to present an import interface on display 120 prompting a user for input data identifying the unstructured data to be converted. Upon receipt of input data from input device 116 identifying unstructured data 140, processor 108 is configured to retrieve unstructured data 140 (for example, by loading unstructured data from non-volatile memory into volatile memory) for further processing.

At block 310, processor 108 is configured to determine whether a template has been identified for use during the conversion of unstructured data 140. Templates are files defining associations between unstructured data 140 and the predetermined format used by application 132. As will be discussed in further detail below, a template specifies a set of properties of unstructured data 140, such as field names, keywords and the like, in association with a corresponding set of properties defined by the predetermined format used by application 132, in effect mapping unstructured data 140 to the predetermined format. As will be seen below, templates are created and updated during repeated performances of the conversion process of method 300. A template created during a previous conversion process can be identified in the input data received at block 305, in which case processor 108 loads the identified template at block 315 and applies the template at block 320. However, in the present example performance of method 300, it is assumed that no template has been identified because unstructured data 140 has not been converted previously, and thus a template does not yet exist.

The determination at block 310 is therefore negative, and processor 108 proceeds to block 325, at which a set of default parsing rules is loaded. The default parsing rules are stored in memory 112 in association with application 132, and comprise computer-readable instructions for determining associations between properties of unstructured data 140 and the predetermined format used by application 132. In other words, the default parsing rules are used by processor 108 to determine the associations that will later be stored in a template.

The nature of the default parsing rules is not particularly limited. In general, the default parsing rules specify properties to be detected in unstructured data 140, and actions to take when those properties are detected. Thus, the parsing rules cause processor 108 to divide unstructured data 140 into sections (sections represent artifacts in structured data 138) when certain properties identified in the rules are detected; to store hierarchical relationships between the sections based on properties identified in the rules and on similarities between sections also specified in the rules (such as a certain degree of overlap in content); and to extract additional information concerning the sections.

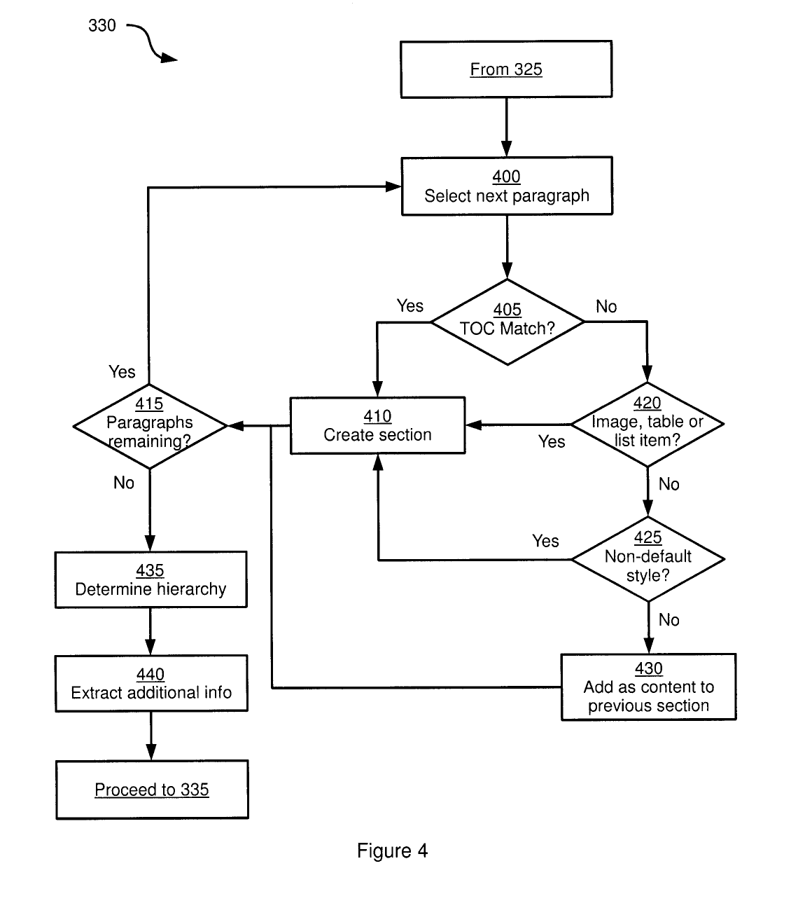

Having retrieved the default parsing rules at block 325, processor 108 is configured to apply the default parsing rules to unstructured data 140 at block 330. Applying the parsing rules includes traversing unstructured data 140 and, for each paragraph, or other defined portion of unstructured data 140, making a series of determinations by comparing the properties of the paragraph to the properties in the parsing rules. FIG. 4 shows an example of those determinations, though it is contemplated that the determinations shown in FIG. 4 can be varied.

Referring now to FIG. 4, an example of the performance of block 330 is shown. Beginning at block 400, processor 108 is configured to select the next unprocessed paragraph of unstructured data 140. Thus, in the present example, processor 108 is configured to select the first paragraph of unstructured data 140, which is the heading “1. Glossary” shown in FIG. 2 (in the present example, the table of contents on page 200 is not parsed directly, but is instead used as a reference during parsing).

Processor 108 is then configured at block 405 to determine whether the selected paragraph contains text that matches any entries in the table of contents. In the present example, the determination is affirmative, and thus processor 108 is configured to create a section at block 410. Sections created during the parsing of unstructured data can be stored in memory 112. The creation of a section at block 410 includes assigning a name to the section, if the current paragraph contains text. If the current paragraph contains only an image, and no text that can be used as a name (for example, text may be present but may not meet formatting criteria to be interpreted as a name), a placeholder such as the string “<no title found>” can be assigned. the name can be omitted. Continuing with the example of the “1. Glossary” paragraph, the section created at block 410 is assigned the name “Glossary” by processor 108 (processor 108 can optionally be configured to ignore leading numerals). In addition, processor 108 can assign a type to the section, corresponding to an artifact type. For example, the default parsing rules can configure processor 108 to match keywords in unstructured data 140 to artifact types. As another example, processor 108 can be configured to assign the type “folder” (a type of artifact that contains other artifacts) to sections that consist only of headings matching the table of contents. In the present example, processor 108 is configured to assign the type “glossary” to any section that contains the term “glossary”.

Having created a section, processor 108 is configured to determine whether any unprocessed sections remain. In the present example, the determination is affirmative since the remainder of unstructured data 140 has not yet been parsed, and therefore processor 108 returns to block 400 and selects the next paragraph. The next paragraph is the string of text “Term 1: definition”. Proceeding to block 405, processor 108 determines that there is no match with the table of contents, since the above string does not appear on page 200. Processor 108 therefore proceeds to block 420 and determines whether the current paragraph is an image, a table, or a list item. The default parsing rules can include rules specifying that images, tables and list items are to be divided into separate sections. If the determination at block 420 were to be affirmative, a new section would be created, as described above.

The default parsing rules relating to tables can cause processor 108 to take a variety of actions when tables are detected in unstructured data 140. In some examples, a single section can be created for an entire table. In other examples, a new section can be created for each row of the table. Processor 108 can also create a single section for a two-column table, but a new section for each row when a table has more than two columns. Processor 108 can also be configured to detect merged cells in tables and assign the merged cells to one or more columns, for example based on a width property of the table. Section fields can be generated from the header row of a table, and in some examples the predetermined format used by application 132 allows entirely new fields to be created during the parsing process. For example, it is possible that the “priority” header in page 208 is not specified in the predetermined format, but processor 108 can nevertheless add a “priority” field to a section created for each record of the table. The predetermined format will effectively have been extended.

In the present performance of method 300, however, the string “Term 1: definition” is not an image, table or list item, and the determination at block 420 is therefore negative. Processor 108 therefore proceeds to block 425 and determines whether the above string has a style (e.g. font and font size, line spacing and the like) that is different from a default style defined in unstructured data 140. If the determination at block 425 is affirmative, a section is created at block 415, as described above. In the present example, it is assumed that the string “Term 1: definition” uses the default style in unstructured data 140, and the determination at block 425 is therefore negative.

Processor 108 then proceeds to block 430, where it is configured to add the current paragraph to the previously defined section. As a result, the string “Term 1: definition” is added to the “Glossary” section defined in the previous iteration of block 330. It is contemplated that additional terms (not shown) can be added to the same Glossary section if present.

Processor 108 then proceeds to block 415, and repeats the above determinations until all paragraphs in unstructured data 140 have been processed. At that point, the determination at block 415 is negative because no paragraphs remain to be processed, and processor 108 proceeds to block 435.

At block 435, processor 108 is configured to determine a hierarchy among the sections created through repeated performances of block 410. In some examples, the hierarchy can be determined during the identification of sections, instead of after the sections have been identified. Determination of hierarchy is not particularly limited, and can be based on any suitable combination of the following: indentations in the table of contents of unstructured data 140; whether or not the section appears in the table of contents; indentations of the paragraphs of unstructured data (a section created from a paragraph with a greater indentation than the previous paragraph can be marked as a child of the section created from that previous paragraph); font size and other style attributes (for example, larger font sizes and other style attributes can indicate a higher level in the hierarchy); and relatedness of textual content, using algorithms such as the Latent Semantic Indexing (LSI) and Porter stemming algorithms. When a hierarchical relationship is determined between two sections at block 435, processor 108 can be configured to store a reference to the child section in the parent section.

It is contemplated that in some instances, the factors enumerated above that are considered by processor 108 in determining section hierarchy may result in conflicting determinations. For example, a paragraph may use a larger font size than the previous paragraph—indicating according to a parsing rule that the paragraph is not a child of the previous paragraph—but a greater level of indentation, indicating according to a different parsing rule that the paragraph is a child of the previous paragraph. When such conflicts between parsing rules arise, processor 108 can be configured to select one of the conflicting rules over the others according to a predetermined priority order, or according to a predetermined weighted average.

Processor 108 is then configured to extract additional data for the sections created from unstructured data 140. This step can also be performed simultaneously with the creation of the sections at block 415, rather than separately after the sections have been created. In any event, processor 108 is configured to determine whether any paragraphs of unstructured data 140 contain hyperlinks or bookmarks to other paragraphs. If any such links are detected, processor 108 is configured to store each link in the section corresponding to the link's location, as a reference to section corresponding to the link's target. Page 212, for example, contains a link to a portion of page 208 (see the string “See functional req. 2”). Processor 108 is also configured to identify data such as comments or embedded documents (e.g. a portable document format (PDF) document, word processing document, spreadsheet document, and the like, can be embedded in a paragraph) and store such data in the section corresponding to the paragraph containing the data.

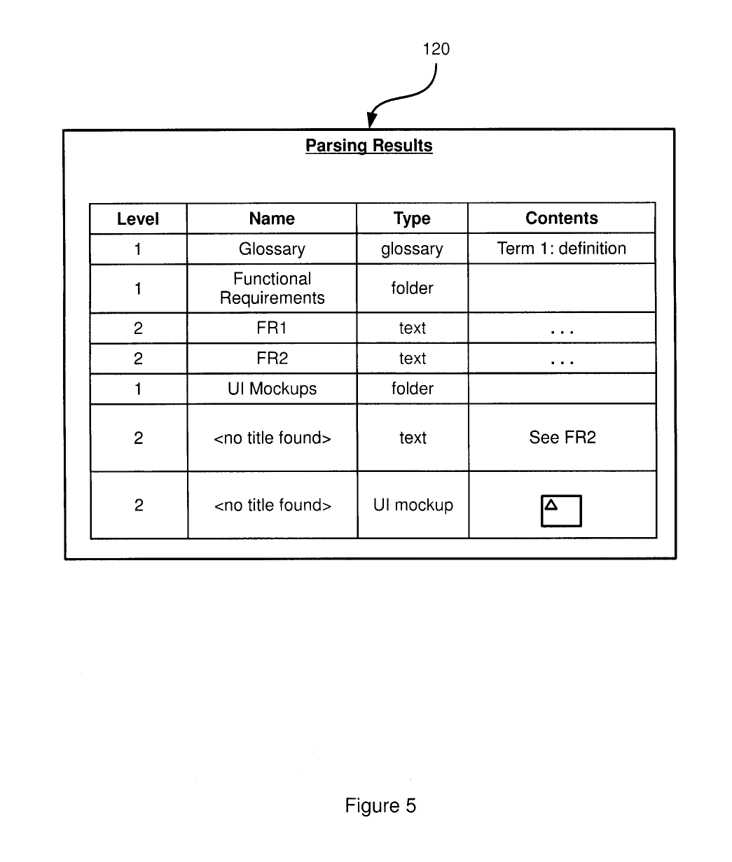

Once the parsing of unstructured data 140 is complete, processor 108 is configured to perform block 335 of method 300 (shown in FIG. 3). At block 335, processor 108 is configured to control display 120 to present the results of the parsing performed at block 330. FIG. 5 depicts a simplified example of the presentation of parsing results at block 335. In particular, FIG. 5 shows the results of following the processing flow of FIG. 4 for pages 204, 208 and 212 of unstructured data 140. Each row in the table shown in FIG. 5 is one section created during the parsing of pages 204, 208 and 212. A hierarchy level is indicated in the left-most column, followed by a name of the section, a type of the section, and the contents of the section. It will now be apparent that the sections shown in FIG. 5 are organized according to the predetermined format: the fields of each section correspond to fields of the predetermined format. Although not shown in FIG. 5, some sections can be illustrated in more than one way. For example, multiple sections may be shown as a single section, with an associated interface element that can be selected to separate them. This functionality can be implemented when the above-mentioned rule priority or weighted average indicates that the sections may be closely related. For example, the rule having the highest priority may identify three separate sections, while the rule with the second-highest priority may identify the three sections as a single section. This is referred to as a “soft merge”. Other examples of section illustration include the ability to display a section in plain text or rich text, and the ability to display tables as text or as a set of properties. These alternatives are selectable by way of interface elements.

Returning to FIG. 3, processor 108 is then configured to proceed to block 340, where it receives changes (if any) to the parsing results displayed at block 335. The interface shown in FIG. 5 can include elements (e.g. buttons and drop-down menus) that are selectable using input device 116 to change the structure and contents of the sections. For example, sections can be merged with one another or divided into multiple sections. Further, sections can be renamed, assigned different types than the types determined at block 330, and so on. When hierarchy conflicts are displayed, the input data received at block 340 can include a selection of which of the conflicting hierarchies to keep.

In the present example performance of method 300, it is assumed that input data is received at processor 108 from input device 116 at block 340, representing changes to the sections shown in FIG. 5. Such input data, in effect, overrides the parsing provided by the default parsing rules.

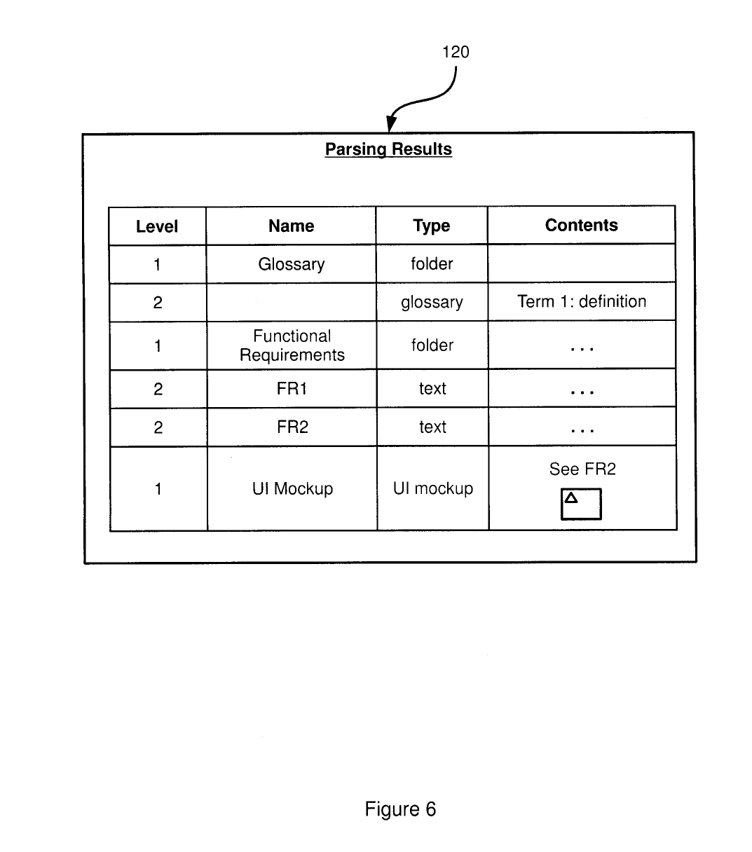

FIG. 6 depicts an updated interface, presented on display 120 following the receipt of input data at block 340. In particular, input data has been received breaking the first section identified by the default parsing rules into two sections, combining the final three sections into a single section, and reassigning some section types. The changes shown in FIG. 6 are purely exemplary—a wide variety of changes can be made to the parsing results in order to improve compliance with the predetermined format used by application 132. For example, in some implementations, terms in glossary-type artifacts may be stored as fields, or sub-artifacts, within a single artifact as shown in FIG. 5.

Once all changes have been received (signaled, for example, by the selection of a “complete” element in the interface of FIG. 6), processor 108 proceeds to block 345. At block 345, processor 108 is configured to create a template, or to update a template if a template was used in the parsing process, based on the changes received at block 340. In the present example, no template was identified at block 310, and so processor 108 is configured to create a new template.

Processor 108 is therefore configured to create a new template file, such as an XML file (although a wide variety of other file formats can also be used). The template contains a record, defined by one or more XML elements, for each of the “finalized” sections as shown in FIG. 6.

Each record of the template identifies the properties—such as font size, indentation, keywords, and the like—of the portion of unstructured data 140 from which the corresponding section was generated. Each record also identifies the fields of the corresponding section and the values of those fields. The values of the fields can be specified explicitly, or can be references to the unstructured data. Thus, taking the “glossary” folder-type artifact of FIG. 6 as an example, the template identifies bold and underlined text and the keyword “glossary” as properties in unstructured data. The template also identifies the level, name, type, and contents fields of the section, and can explicitly identify the values of the level and type fields as “1” and “folder”, respectively. The template also identifies the value of the name field as being equivalent to the keyword used to identify the name field (“glossary”). In other examples, the value of the name field can be identified as a reference to unstructured data 140, instructing processor 108 to place the portion of unstructured data 140 having the above-mentioned properties in the name field, whatever the exact value of that portion happens to be (such as “Glossary Part A”, for example).

The template is populated with an additional record for each of the remaining sections shown in FIG. 6. The nature of each record in the template is not particularly limited. For example, some artifacts, such as the “UI mockup” artifact, span several paragraphs in unstructured data 140. Thus, the template record for that artifact can specify the properties and sequence of all the relevant paragraphs, as well as which fields of the predetermined format are to be populated with unstructured data having those properties and sequence.

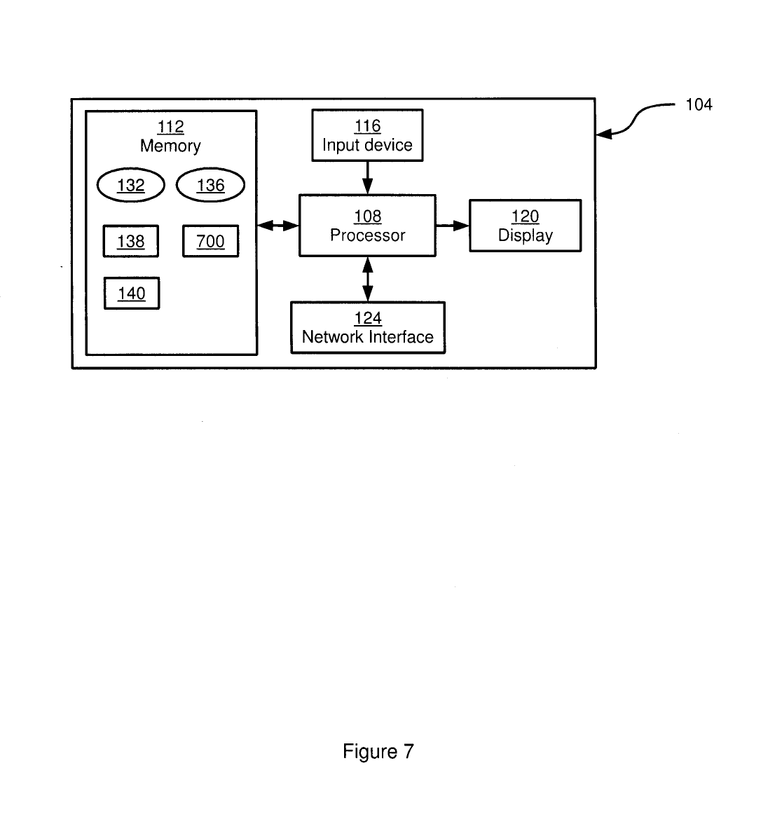

Having created the template, processor 108 is configured to save the template to memory 112—FIG. 7 depicts computing device 104 in which memory 112 now contains a template 700.

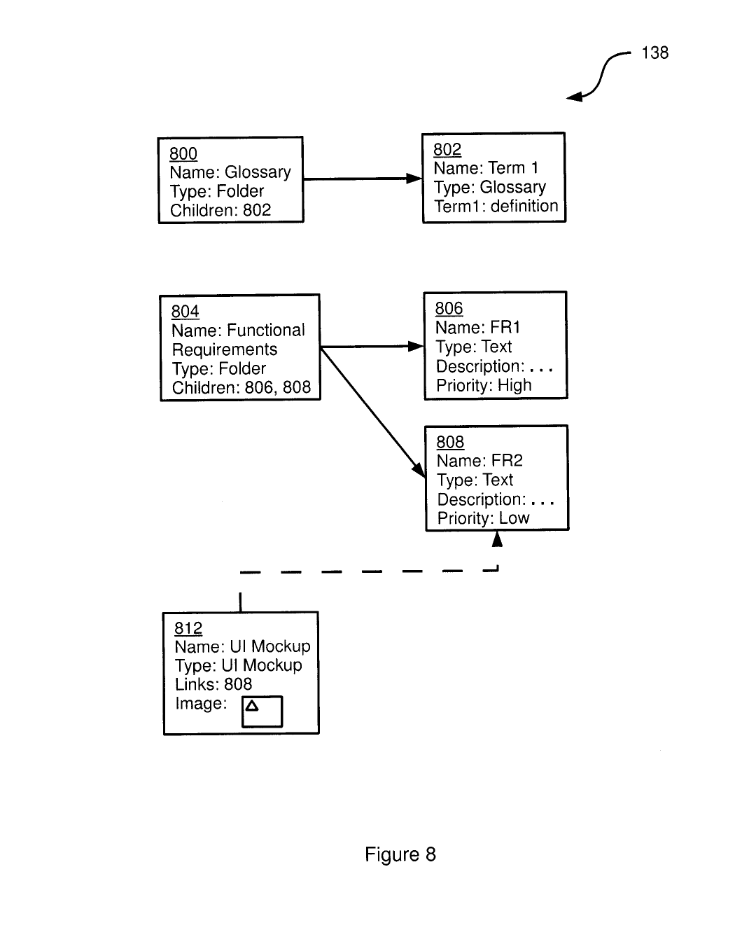

Referring again to FIG. 3, processor 108 is then configured, at block 350, to store the finalized sections created from unstructured data 140 according to the predetermined format used by application 132. Thus, the sections shown in FIG. 6 are each stored in structured data 138 as elements and attributes representing artifacts and their contents and properties. FIG. 8 depicts a schematic illustration of the resulting XML file in structured data 138. In particular, artifacts 800, 802, 804, 806, 808 and 812 are generated from the sections shown in FIG. 6. Solid arrows denote parent-child relationships between artifacts (which are also defined by fields within the artifacts), and broken-line arrows represent links, also referred to as traces, between artifacts.

With the storage of sections as structured data 138, the conversion process is complete. As shown in FIG. 3, however, the performance of method 300 can be repeated. A second performance of method 300 will now be described.

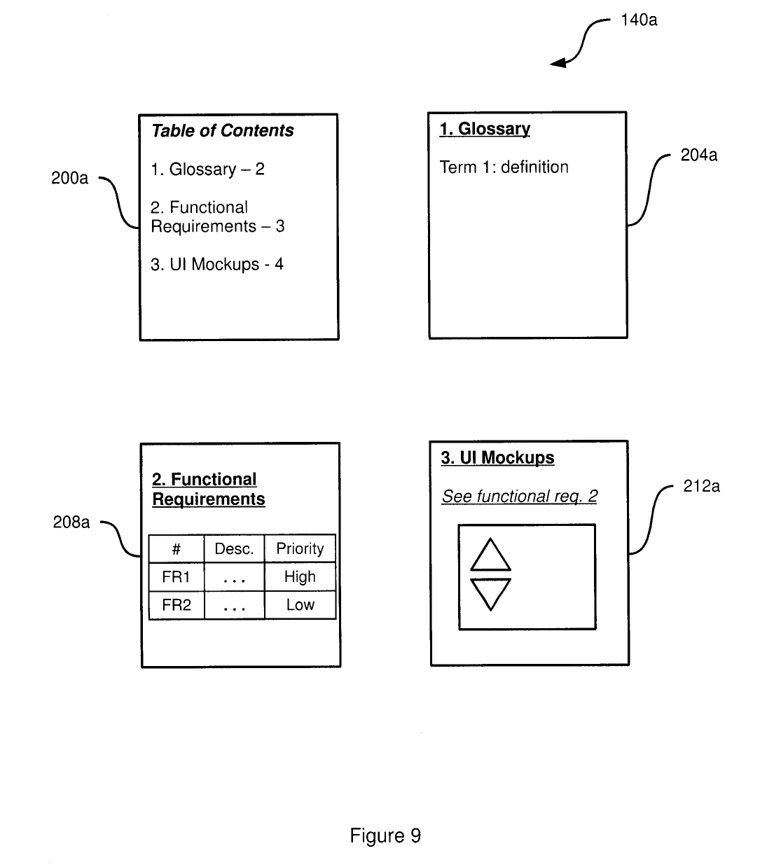

Beginning again at block 305, processor 108 is assumed to receive input data identifying a modified version 140a of unstructured data 140, shown in FIG. 9. As seen in FIG. 9, pages 200a, 204a and 208a are unchanged, but the image included in page 212a has been modified. Proceeding to block 310, in this performance of method 300 the determination at block 310 is affirmative, as input data is received at processor 108 identifying template 700. Thus, processor 108 loads template 700 at block 315, and proceeds to block 320.

At block 320, rather than applying the default parsing rules as described above, processor 108 compares the contents of unstructured data 140a to template 700. Whenever a match is found between the properties of one or more paragraphs of unstructured data 140a and the properties specified for a given section in template 700, processor 108 creates a section having the attributes specified in template 700.

If a paragraph, or group of paragraphs, in unstructured data 140a do not match any of the records of template 700, then processor 108 can be configured to parse the non-matching paragraphs using the default parsing rules, as illustrated by the broken line between blocks 320 and 325 in FIG. 3.

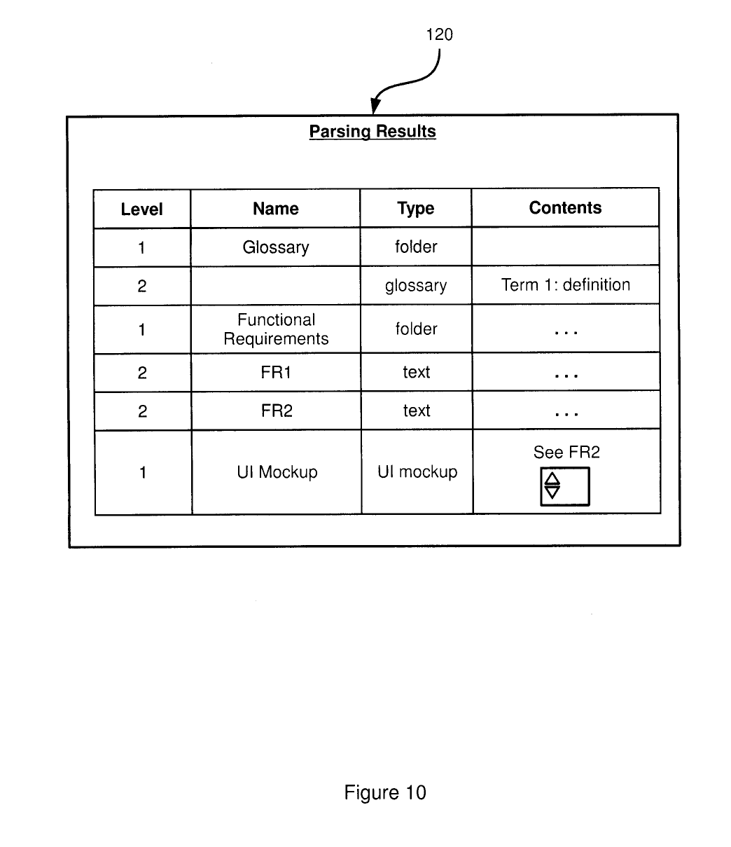

Following the parsing of unstructured data 140a, processor 108 is configured to display the results of parsing at block 335. FIG. 10 depicts a simplified example of the results of block 320 (and possibly block 330, if non-matching paragraphs are detected). Of particular note, the sections defined in FIG. 10 correspond to those defined in FIG. 6, after the receipt of changes at block 340. In other words, the storage of changes to parsing results in template 700 can reduce or obviate the need to make further changes in subsequent conversions.

If any changes are required to the parsing results shown in FIG. 10, they are received at block 340, and template 700 is updated at block 345 to modify existing records or to add new records. For example, if unstructured data 140a included an additional page whose paragraphs did not match any of the records in template 700, template 700 could be expanded to include a new record associating the properties of those paragraphs with section attributes.

As will now be apparent to those skilled in the art, the conversion of multiple similar unstructured documents (for example, multiple versions of the same unstructured document) can improve the conversion accuracy provided by template 700. For unstructured documents with widely diverging content, it may be preferable to use separate templates. It is possible to use the same template for such documents, but if the contents of different unstructured documents is widely divergent, then significant changes to the single template may be required with each conversion process.

In addition to the variations mentioned above, further variations may be made to the devices and methods described herein. In other embodiments, conversion application 136 can be used to convert unstructured data 140 into a predetermined format used by an application other than application 132. For example, memory 112 can store a plurality of sets of default parsing rules, each set being adapted for converting unstructured data 140 to a different predetermined format. Additional variations will also occur to those skilled in the art.

Those skilled in the art will appreciate that in some embodiments, the functionality of applications 132 and 136 may be implemented using pre-programmed hardware or firmware elements (e.g., application specific integrated circuits (ASICs), electrically erasable programmable read-only memories (EEPROMs), etc.), or other related components.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A computing device for converting unstructured data to structured data having a predetermined format, comprising:
a memory storing the unstructured data;
an input device;
a display;
a processor interconnected with the memory, the input device and the display, and configured to:
retrieve the unstructured data from the memory;
load parsing rules defining associations between one or more properties of the unstructured data and the predetermined format;
apply the parsing rules to the unstructured data to divide the unstructured data into a plurality of sections, each section containing a different portion of the unstructured data in one or more fields defined by the predetermined format;
present the sections on the display;
generate a template based on the sections, the template including, for each section, a record identifying the properties of the portion of the unstructured data contained in that section, and identifying the one or more fields of the predetermined format and values for the one or more fields;
store the template in the memory; and
store the sections as structured data in the memory.

2. The computing device of claim 1, the processor further configured, prior to generating the template, to:
receive input data representing changes to the displayed sections; and
update the displayed sections;
the processor further configured to generate the template based on the updated sections.

3. The computing device of claim 2, the processor further configured to:
retrieve additional unstructured data from the memory;
load the template;
apply the template to the additional unstructured data to divide the additional unstructured data into a plurality of additional sections; and
store the additional sections as structured data in the memory.

4. The computing device of claim 3, the processor further configured, prior to storing the additional sections, to:
receive further input data representing changes to the additional sections; and
update the template based on the further input data.

5. The computing device of claim 3, the processor further configured, prior to retrieving the additional unstructured data, to:
present an import interface on the display; and
receive an identifier of the additional unstructured data and an identifier of the template via the import interface.

6. The computing device of claim 1, wherein the values include one or both of explicit values and references to the unstructured data.

7. The computing device of claim 1, wherein the one or more properties of the unstructured data include one or more of font size, line spacing and keywords.

8. A method of converting unstructured data to structured data having a predetermined format, comprising:
storing the unstructured data;
retrieving the unstructured data from the memory using a processor;
loading parsing rules defining associations between one or more properties of the unstructured data and the predetermined format;
applying the parsing rules to the unstructured data to divide the unstructured data into a plurality of sections, each section containing a different portion of the unstructured data in one or more fields defined by the predetermined format;
presenting the sections on a display;
generating a template based on the sections, the template including, for each section, a record identifying the properties of the portion of the unstructured data contained in that section, and identifying the one or more fields of the predetermined format and values for the one or more fields;
storing the template in the memory; and
storing the sections as structured data in the memory.

9. The method of claim 8, further comprising:
prior to generating the template_{;} receiving input data at the processor from an input device, representing changes to the displayed sections; and
updating the displayed sections;
wherein the template is generated based on the updated sections.

10. The method of claim 9, further comprising:
retrieving additional unstructured data from the memory;
loading the template;
applying the template to the additional unstructured data to divide the additional unstructured data into a plurality of additional sections; and
storing the additional sections as structured data in the memory.

11. The method of claim 10, further comprising, prior to storing the additional sections:
receiving further input data from the input device representing changes to the additional sections; and
updating the template based on the further input data.

12. The computing device of claim 0, further comprising, prior to retrieving the additional unstructured data:
presenting an import interface on the display; and
receiving an identifier of the additional unstructured data and an identifier of the template via the import interface.

13. The method of claim 8, wherein the values include one or both of explicit values and references to the unstructured data.

14. The method of claim 8, wherein the one or more properties of the unstructured data include one or more of font size, line spacing and keywords.
